(19) United States
(12) Patent Application Publication
(10) Pub. No.: US 2023/0078538 A1
(43) Pub. Date: Mar. 16, 2023

(54) COMMUNICATING WITH AN RFID TRANSPONDER

(71) Applicant: Sick AG, Waldkirch (DE)

(72) Inventors: Michael FISLAGE, Waldkirch (DE); Dirk STRUVE, Waldkirch (DE)

(21) Appl. No.: 17/940,326

(22) Filed: Sep. 8, 2022

(30) Foreign Application Priority Data
Sep. 10, 2021 (EP) 21195872.3

(51) Int. Cl. G06K 7/10; G06K 7/00

(52) U.S. Cl. CPC G06K 7/10297; G06K 7/0008; G06K 7/10069

(57) ABSTRACT

An RFID device is provided for communicating with at least one RFID transponder that has a transmitter, a receiver, a transmission antenna and a reception antenna for emitting and receiving RFID signals and has a control and evaluation unit that is configured to transmit and receive an RFID signal in a respective one of a plurality of frequency channels, in particular to encode RFID information into the RFID signal and/or to read information from the RFID signal in accordance with an RFID protocol and to carry out an intensity adaptation of the RFID channel in dependence on the frequency channel used for the transmission and reception.

The invention relates to an RFID device and to a method for communicating with at least one RFID transponder respectively.

RFID systems serve for the identification of objects and products and are used inter alia to automate logistical movements. RFID transponders fastened to the products are read at an identification point, above all on a change of the owner of the product or on a change of the transport means, and information is optionally written back into the transponder. This results in fast and traceable logistical movements. The detected information is used to control the forwarding, storage, and sorting of goods and products.

The RFID transponders are excited by electromagnetic emission of the read/write system, also called an interrogator, for the emission of the stored information, wherein passive transponders obtain the required energy from the transmission energy of the reading system and the less customary active transponders have their own supply for this purpose. Passive transponders are read in accordance with the backscatter method in the established ultrahigh frequency standard EPC Generation 2 UHF RFID, whose air interface is defined in ISO 180000-6.

An RFID device communicates in different frequency channels within a frequency range permissible for RFID. The frequency channel used for a specific communication is dynamically determined in each case to be able to evade other signals, in particular to enable communication with different RFID transponders. The transmission energy of the RFID device is conventionally uniformly set such that communication with an RFID transponder is possible in all the available frequency channels up to the desired reading range. This is done under the framework condition that the maximum permitted transmission power is not exceeded.

The effective transmission power and thus the transmission intensity and the reception intensity are, however, actually frequency dependent due to the characteristics of the involved antennas of the RFID device and the RFID transponder, that is they differ greatly from one another from frequency channel to frequency channel. The transmission energy fixedly set independently of the frequency channel does not meet this requirement. This has to date been an effect that has not been paid attention to and not compensated.

Numerous problems are associated with this. On the one hand, a fixed transmission power results in different reading ranges of the frequency channels. There are then frequency channels that are too weak or too strong depending on the frequency channel the fixed transmission power is adapted to. RFID transponders cannot be read over the whole provided range in too weak a frequency channel. In too strong a frequency channel, on the other hand, the safety margin exaggerated in favor of the weak frequency channels produces an additional excess range at which unwanted distant RFID transponders are possibly detected or interactions with adjacent devices are produced or amplified. The received signal strength indicator (RSSI) is furthermore used for a distance determination and association in some RFID systems. A falsification of the signal strength by the frequency channel forms an additional error source here.

It is therefore the object of the invention to improve the adaptation of an RFID device.

This object is satisfied by an RFID device and by a method for communicating with at least one RFID transponder in accordance with the respective independent claim. The RFID device is also called an interrogator, RFID reader or RFID read/write device, since an RFID device is also preferably able to read and write. A transmitter transmits a transmission signal via a transmission antenna that is received again by a receiver via a reception antenna. The transmitter and the receiver can together be configured as a transceiver and a common transmission/reception antenna can be provided.

A control and evaluation unit selects one of a plurality frequency channels for a respective transmitted RFID signal that is received again. The total available frequency channels are specified in a regulatory and technical manner and possibly also specifically to an application. Information is preferably exchanged with the RFID transponder by the transmission and reception of the RFID signal, i.e. a piece of RFID information is encoded in the transmitted RFID signal that should be communicated to the RFID transponder or should be stored there or by which a specific demand is made or a piece of RFID information of the RFID transponder is read from the received RFID signal. In particular with UHF RFIDs, the transmission signal serves the supply of the RFID transponder that modifies the sent back RFID signal having a requested piece of information

The invention starts from the basic idea of achieving a comparable intensity over the different frequency channels. An intensity adaptation of the RFID signal is carried out for this purpose in dependence on the frequency channel. Intensity is here a term that has been selected as representative and that also covers alternative descriptions of the signal strength via an amplitude of the RFID signal, a transmission and/or transmission power and other such equivalent physical values. The control and evaluation unit preferably knows the relative differences in the intensities of the frequency channels or corresponding correction values for an intensity adaptation, and indeed group-wise for a plurality of similar frequency channels up to individually for every frequency channel. The intensity adaptation takes place in dependence on the embodiment in different manners that can be combined with one another, for example at the transmission and/or reception side, physically and/or in a calculatory manner, and in dependence on an antenna characteristic of the RFID device and/or of the RFID transponder.

The invention has the advantage that the range over all the frequency channels becomes more similar or the same. There are fewer interactions with non-system RFID devices. The transmission power can now be adapted in a much more targeted manner so that only so much power is used as necessary and no more as possible or allowed. Filtering processes or associations based on the signal strength become more reliable. Said advantages are displayed the more with narrow band antennas of the RFID device or of the RFID transponder since then conventionally, without an intensity adaptation in accordance with the invention, the differences over the frequency channels would be particularly pronounced.

The RFID device is preferably configured for the UHF range in accordance with ISO 180000-6. This continues to be establishing and therefore a very relevant standard. The frequency channels are preferably fixed in the (European) ETSI band or the (American) FCC band. ETSI provides 15 channels per 200 KHz between 865 and 868 MHz and FCC 52 channels per 400 KHz between 902 and 928 MHz The larger the number of frequency channels and the bandwidth covered thereby overall, the more pronounced differences can occur without the intensity adaptation in accordance with the invention. The invention can therefore display its strengths particularly well in the FCC band.

The control and evaluation unit is preferably configured to adapt a transmission power of the transmission antenna in dependence on an antenna characteristic of the transmission antenna over the frequency channels. This is preferably still under the framework condition of observing the permitted maximum limits. The transmission antenna or its antenna characteristic is a first possible source of different intensities over the frequency channels. The properties of the RFID device's own transmission antenna are known from the development and can therefore be compensated independently of the RFID transponders to be read and of the application situation. A uniform actual transmission power in the different frequency channels is therefore in particular achieved, in other words the antenna characteristic of the transmission antenna is effectively flattened.

The control and evaluation unit is preferably configured to adapt an amplification of the received RFID signal in dependence on an antenna characteristic of the reception antenna over the frequency channels. This now relates to the reception side, otherwise the considerations with respect to the transmission antenna and its antenna characteristic can be transferred. If there is a common transmission/reception antenna, the effect of the antenna characteristic should nevertheless be taken into account on the reception of the RFID signal.

The control and evaluation unit is preferably configured to adapt a measured intensity of the received RFID signal, in particular an RSSI (received signal strength indicator) value. This is now preferably a calculatory correction, not a physical correction as before. A falsification of the RSSI value by the respective frequency channel used is thus prevented. Filtering processes and associations that are based on the RSSI value thereby become more reliable in that, for example, a common threshold value can be set whose exceeding or falling below no longer depends on the frequency channel.

The control and evaluation unit is preferably configured to carry out the intensity adaptation in the frequency channel used in dependence on an antenna characteristic of the RFID transponder. The RFID signal returned from the RFID transponder namely likewise displays a dependence on the frequency channel previously not considered in the prior art. The RFID device can compensate this, for which purpose in particular each of the previously named measures or any desired combination thereof is suitable. The RFID transponder in particular has a metal substrate (on-metal), whereby intensities not adapted in accordance with the invention would differ particularly greatly over the frequency channels.

Said adaptations to an antenna characteristic of the transmission antenna, the reception antenna, or a correction of the RSSI are possible individually, all together, or in any desired intermediate combinations.

The control and evaluation unit is preferably configured to provide an intensity at least largely independent of the frequency channel used by means of the intensity adaptation. The goal of the intensity adaptation is in other words an intensity that is the same over all the frequency channels and that does not have to or cannot be perfectly achieved in practice. The intensity adaptation therefore provides a strengthening of previously weak frequency channels and/or a weakening of previously strong frequency channels. The reasons why frequency channels are formed as differently weak or strong can, as discussed, be found in the transmission antenna, the reception antenna, and the associated analog circuits and/or in the RFID transponder with its transponder antenna. The intensity adaptation in turn preferably takes place via one of said measures or combinations thereof.

The control and evaluation unit is preferably configured to align the intensity adaptation to the weakest frequency channel. It is that frequency channel in which the weakest RFID signal or the smallest RSSI would be determined and the smallest reading range reached under otherwise the same conditions. In this weakest frequency channel, the intensity should be sufficient for the provided reading range, a still lower intensity could result in reading failures. In accordance with the prior art, the other frequency channels would operate at excess intensity to ensure the minimum range as the worst case scenario in the weakest frequency channel and an excess range having all the problems named in the introduction would thereby be generated. In accordance with the invention, in contrast, the remaining channels can be weakened by intensity adaptation to avoid these problems.

The control and evaluation unit is preferably configured to determine the intensity of the received RFID signal on communication with an RFID transponder in different frequency channels. This serves for the teaching or calibrating of the intensity adaptation or the determination of corresponding correction values and is preferably done in advance using a known RFID transponder in a fixed reading range. The determination can be performed individually for each unit or only generally for a certain class of RFID devices and/or RFID transponders and is done directly at the location of the application or earlier, for example, in final production. A measurement is made of how the intensities behave relative to one another in the frequency channels. A measurement is preferably made for this purpose in all the frequency channels via which communication could take place in principle in operation. It is, however, also conceivable to interpolate from fewer frequency channels or to estimate the dependence of the intensity on the frequency channels from some sampling points. Alternatively to a measurement, it is conceivable to support the intensity adaptation on calculatory predictions or predictions acquired by simulation of in particular the antenna characteristics on the transmission reception and/or transponder antenna. The measurement has the advantage that all the actual system properties are detected and, when carrying out the measurement at the application site, even also application-specific influence factors can be detected.

The control and evaluation unit is preferably configured to determine a required intensity adaptation per frequency channel by parameterization to a type of RFID transponders. Intensity adaptations or correction values on the type of RFID transponder are accordingly stored that are selected by the parameterization. The stored intensity adaptations can have any desired format, for example as a functional relationship of intensity adaptation to frequency or as a lookup table (LUT).

The control and evaluation unit is preferably configured to determine a required intensity adaptation per frequency channel by reading intensity adaptation information from an RFID transponder. The RFID transponder thus knows its own antenna characteristic or the intensity differences in the frequency channels thereby generated and hands over this information to the RFID device on request. The format of this information can vary in dependence on the embodiment as in the parameterization explained in the previous paragraph, for example can be a simple description of the characteristics of the transponder antenna by a few parameters such as the maximum and the bandwidth or a complete characteristic having a value per frequency channel or correction values are already communicated between the frequency channels for adjustment.

A determination of the relative strengths of the frequency channels is required in advance at some point for a parameterization with reference to an RFID transponder type or so that the RFID transponder can communicate the required intensity adaptation. For this purpose, all the above-described possibilities, including the measurement or calibration, the modeling, and the simulation are conceivable. It can, however then be outsourced, for example in the final production or even as early as the development of the RFID device.

The method in accordance with the invention can be further developed in a similar manner and shows similar advantages in so doing. Such advantageous features are described in an exemplary, but not exclusive manner in the subordinate claims dependent on the independent claims.

In this respect, a required intensity adaptation per intensity channel is preferably determined in advance by determining the intensity of the received RFID signal in different frequency channels. This is preferably done while changing the frequency channel under otherwise the same conditions, in particular in communication with the respective same RFID transponder in a fixed position. As already stated, this is representative for a class or a type of RFID devices and/or radio transponders, but also for individual units or even specific to the application.

The invention will be explained in more detail in the following also with respect to further features and advantages by way of example with reference to embodiments and to the enclosed drawing. The Figures of the drawing show in:

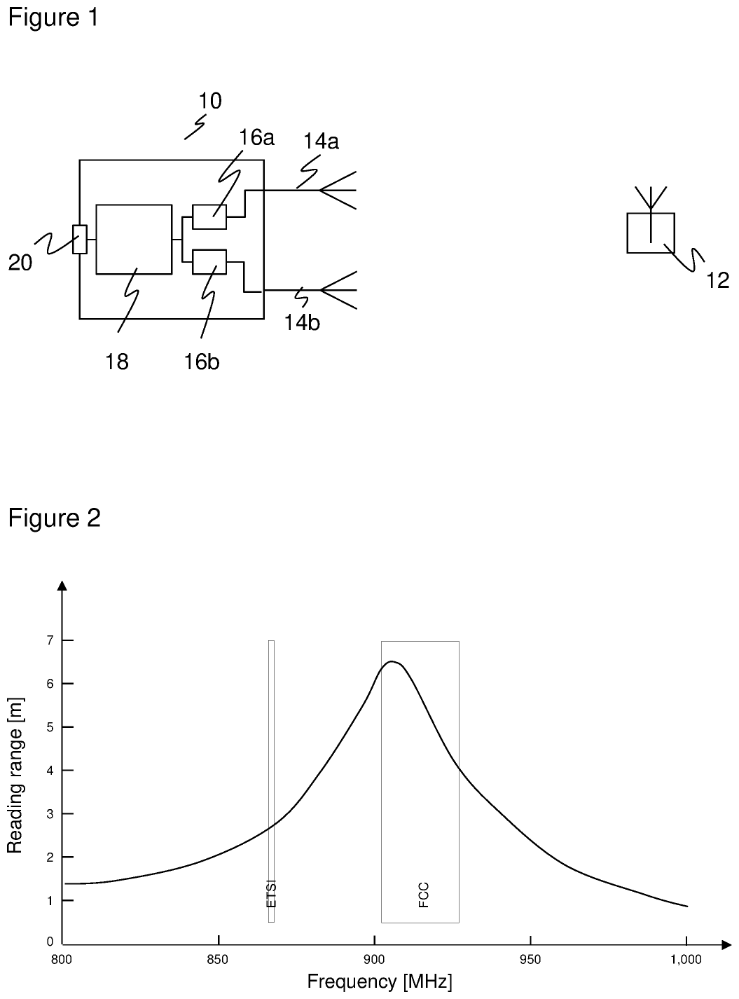

FIG. 1 a schematic overview representation of an RFID device having a plurality of RFID transponders in reading range;

FIG. 2 an exemplary frequency characteristic of an RFID transponder;

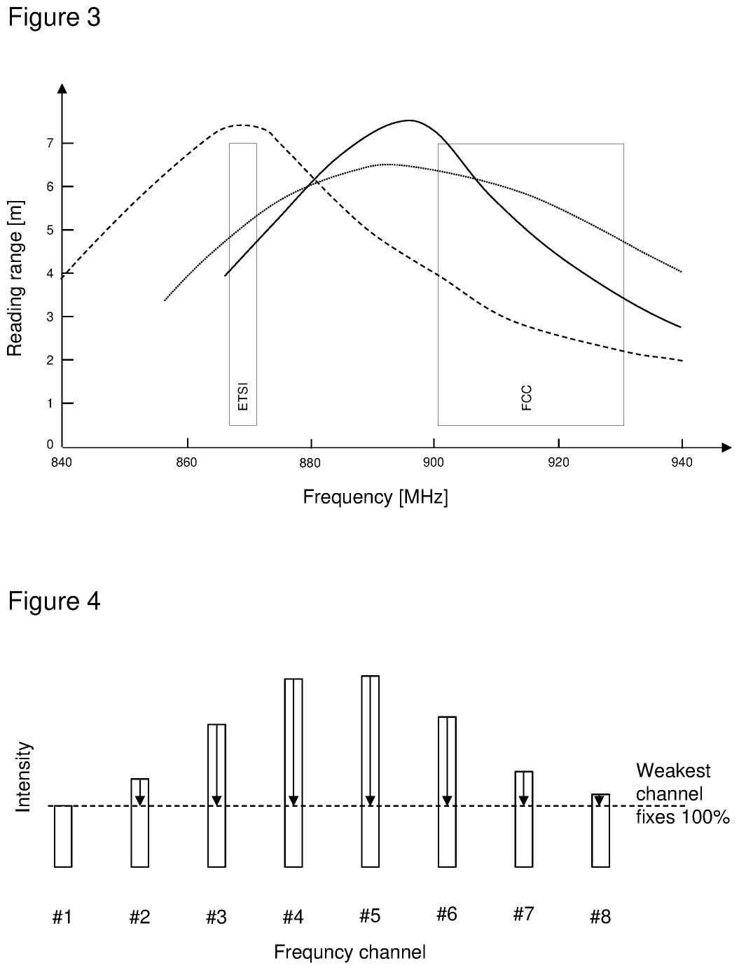

FIG. 3 a comparison of the frequency characteristics of different RFID transponders; and

FIG. 4 a schematic representation of an embodiment of an intensity adaptation in different frequency channels.

FIG. 1 shows a schematic overview representation of an RFID device 10 and of an RFID transponder 12 arranged in an exemplary manner in its reading range. The RFID device 10 in this embodiment has a respective separate transmission antenna 14a and reception antenna 14b, wherein a transmitter 16a emits an RFID signal via the transmission antenna 14a or a receiver 16b again receives the RFID signal 14d via the reception antenna. The separation at the hardware side into a transmission channel and a reception channel is also practically conceivable, but primarily serves for the conceptional representation to separately explain the effects at the transmission and reception sides. In other embodiments, a common transmission/reception antenna replaces the individual transmission antenna 14a and reception antenna 14b and/or a transceiver replaces the transmitter 16a and receiver 16b.

A control unit 18, for example having a digital module such as a microprocessor or an FPGA (field programmable gate array) controls the routines in the RFID device 10 and is able to encode RFID information into an RFID signal or to read RFID information from an RFID signal. A wired or wireless connector 20 serves to integrate the RFID reading apparatus 10 into a higher ranking system.

In detail, the communication preferably takes place in accordance with a known RFID protocol, in particular ISO 18000-6 or EPC Generation-2 UHF RFID, and the steps and components required for this are known per se. The exact setup of the RFID reading device 10 beyond the rough functional blocks is equally considered known that is in another respect only shown purely schematically in this form and can alternatively adopt any other arrangement known per se of the explained elements.

RFID communication takes place on one frequency channel from a plurality of frequency channels. For example, 15 frequency channels are provided in the ETSI band from 865 to 868 Hz and 52 frequency channels in the FCC band from 902 to 928 MHz The transmitted and received intensity of the RFID signal and thus the reading range vary with the frequency and therefore differ in the frequency channels. There are a plurality of possible reasons for this frequency behavior. They include the frequency characteristic of the transmission antenna 14a, the reception antenna 14b, and the transponder antenna of the RFID transponder 12. The specific application environment and the arrangements of the RFID device 10 and the RFID transponder 12 and its material can have an effect on the frequency behavior.

FIG. 2 shows by way of example the reading range in dependence on the frequency of the RFID signal for an RFID transponder having a metal substrate (on-metal) for the FCC band. The maximum reading range is achieved at approximately 905 MHz with this transponder, with a reading range of approximately 6.5 m. A maximum at 915 MHz would be better suited for an optimum coordination with the FCC band since the reading range drops to approximately 4 m at the upper end of the FCC band.

Only the total curve ca be rescaled upwardly or downwardly by conventional only across-the-board adaptation of the transmission power. This then either results in reading failures in weak frequency channels or in excess ranges in strong frequency channels. In accordance with the invention, an intensity adaptation per frequency channel is in contrast made possible by which the curve is flattened. A uniform reading range in all the frequency channels can thus be achieved. The intensity, signal strength, and reading range are coupled to one another. When an intensity adaptation is spoken of in the following, it means an adaptation of the coupled parameters without wording this separately at every point.

The frequency dependence of the intensity is in part based on properties of the RFID device 10, in particular an antenna characteristic of the transmission antenna 14a and the reception antenna 14b. The RFID transponder contributes a further portion whose transponder antenna likewise has antenna characteristic so that more or less intensity is also returned for this reason depending on the current frequency channel.

FIG. 3 shows for this purpose in a similar representation to FIG. 2 the reading range in dependence on the frequency for a plurality of different RFID transponders. The dashed curve corresponds to a well-coordinated ETSI transponder. There would be little need for action here; the curve is already per se largely flat within the ETSI band. However, this RFID transponder in the FCC band would only be readable at short ranges and less suitable for this purpose. The solid curve corresponds to an RFID transponder that attempts a compromise for a global coordination between the ETSI band and the FCC band, but only at the price of very high variations over the frequency channels. There is in particular a fall of the reading range in the FCC band from 7 m to 3.5 m. The dotted curve reduces this effect a little, but still shows values between 6.5 m and 4.5 m in the FCC band. A transponder for the FCC band could be added from FIG. 2, but it still shows a drop from 6.5 m to 4 m despite the close coordination with the FCC band.

The control and evaluation unit 18 can first compensate the frequency characteristic of its own antennas 14a-b to find a suitable intensity adaptation. The frequency characteristic for a specific type of RFID device 10 is known from the development so that the transmission power can be lowered or increased as compensation depending on the frequency channel. A further conceivable measure is an adaptation of the receiver-side amplification or a calculatory receiver-side compensation, for example by correcting an RSSI value. The frequency characteristic of the RFID transponder 12 can likewise be known from a datasheet or can be measured per type and then correspondingly compensated.

It is furthermore conceivable to measure the RFID system from the RFID device 10 and RFID transponder 12 in that communication takes place with a fixed transmission energy with a specific RFID transponder sequentially over the different frequency channels and the received intensity is measured. Curves such as those of FIGS. 2 and 3 can thereby be empirically determined. Such measurements can be carried out individually for a specific RFID system, even at its application site, but alternatively also in the lab for a specific type of RFID device 10 and/or RFID transponder 12. In an embodiment, a teaching or calibration phase in which these measurements are carried out is provided for this purpose. This is alternatively done very independently in advance and the results for a certain type of RFID transponder 12 are stored. The RFID device 10 can then later be parameterized for this, that is the transponder type can be set. In a further alternative, the RFID transponder 12 itself also communicates the information required for the intensity adaptation by means of RFID communication.

The relative strengths of the frequency channels are thus known and they can be corrected to a common level. There is still the freedom to select this common level. There are again different possibilities for this, for instance use of the maximum permitted transmission energy with the result of a maximum reading range that the weakest channel determines, but without an excess range being forced on the other channels as in the prior art. The common level is preferably coordinated such that the weakest channel achieves a specific reading range, as explained now for an exemplary specific embodiment.

FIG. 4 schematically shows the intensity adaptation in eight frequency channels by way of example here. The weakest frequency channel fixes the common level with which a desired reading range can be achieved. For this purpose, the transmitter power varies on communication over the weakest frequency channel until stable communication with an RFID transponder 12 is possible in the reading range.

The intensity is lowered or the RSSI corrected in accordance with the known frequency characteristic in all other frequency channels, as indicated by arrows. The desired reading range is thereby also only reached here and an excess width is avoided. The dependence of the intensity and thus of the reading range on the respectively used frequency channel is eliminated. In this respect, a complete leveling as in FIG. 4 is only the desired ideal state, even an only partial flattening already represents a considerable advantage.

FIG. 4 only shows a preferred embodiment. It would be conceivable even intentionally to deviate from the flattening shown, for example to have a frequency channel available that has a higher reading range as necessary. It is furthermore admittedly advantageous, but not necessary to align the common level to the weakest channel.

1. An RFID device for communicating with at least one RFID transponder that has a transmitter, a receiver, a transmission antenna and a reception antenna for emitting and receiving RFID signals and a control and evaluation unit that is configured to transmit and receive an RFID signal in a respective one of a plurality of frequency channels,
wherein the control and evaluation unit is furthermore configured to carry out an intensity adaptation of the RFID signal in dependence on the frequency channel used for the transmission and reception.

2. The RFID device in accordance with claim 1,
wherein the control and evaluation unit is configured to encode RFID information into the RFID signal and/or to read information from the RFID signal.

3. The RFID device in accordance with claim 1,
wherein the control and evaluation unit is configured to encode RFID information into the RFID signal and/or to read information from the RFID signal in accordance with an RFID protocol,

4. The RFID device in accordance with claim 1,
wherein the RFID device is configured for the UHF range in accordance with ISO 180000-6.

5. The RFID device in accordance with claim 4,
wherein the frequency channels are fixed in the ETSI or FCC band.

6. The RFID device in accordance with claim 1,
wherein the control and evaluation unit is configured to adapt a transmission power of the transmission antenna in dependence on an antenna characteristic of the transmission antenna over the frequency channels.

7. The RFID device in accordance with claim 1,
wherein the control and evaluation unit is configured to adapt an amplification of the received RFID signal in dependence on an antenna characteristic of the reception antenna over the frequency channels.

8. The RFID device in accordance with claim 1,
wherein the control and evaluation unit is configured to recognize a measured intensity of the received RFID signal.

9. The RFID device in accordance with claim 8,
wherein the control and evaluation unit is configured to recognize anan RSSI value.

10. The RFID device in accordance with claim 1,
wherein the control and evaluation unit is configured to carry out the intensity adaptation in the used frequency channel in dependence on an antenna characteristic of the RFID transponder

11. The RFID device in accordance with claim 1,
wherein the control and evaluation unit is configured to provide an intensity at least largely independent of the frequency channel used by means of the intensity adaptation.

12. The RFID device in accordance with claim 1,
wherein the control and evaluation is configured to align the intensity adaptation to the weakest frequency channel.

13. The RFID device in accordance with claim 1,
wherein the control and evaluation unit is configured to determine the intensity of the received RFID signal on communication with an RFID transponder in different frequency channels.

14. The RFID device in accordance with claim 1,
wherein the control and evaluation unit is configured to determine a required intensity adaptation per frequency channel by parameterization to a type of RFID transponders.

15. The RFID device in accordance with claim 1,
wherein the control and evaluation unit is configured to determine a required intensity adaptation per frequency channel by reading intensity adaptation information from an RFID transponder.

16. A method of communicating with at least one RFID transponder, in which method a transmitter emits an RFID signal via a transmission antenna in a respective one of a plurality of frequency channels and the RFID signal is received in a receiver via a reception antenna, wherein a piece of RFID information is encoded into the transmitted RFID signal and/or is read from the received RFID signal, and
wherein an intensity adaptation of the RFID signal is carried out in dependence on the frequency channel used for the transmission and reception.

17. The method in accordance with claim 16,
wherein the piece of RFID information is encoded into the transmitted RFID signal and/or is read from the received RFID signal in accordance with an RFID protocol.

18. The method in accordance with claim 16,
wherein a required intensity adaptation per intensity channel is determined in advance by determining the intensity of the received RFID signal in different frequency channels.
